(19) United States
(12) Patent Application Publication
(10) Pub. No.: US 2010/0282736 A1
(43) Pub. Date: Nov. 11, 2010

(54) SURFACE HEATING SYSTEM

(75) Inventors: Hans-Gunter Koch, Bad Berneck (DE); Peter Ubelmesser, Bayreuth (DE)

Correspondence Address: YOUNG BASILE, 3001 WEST BIG BEAVER ROAD, SUITE 624, TROY, MI, 48084, US

(73) Assignee: FRENZELIT-WERKE GMBH & CO. KG, Bad Berneck (DE)

(21) Appl. No.: 12/671,797

(22) PCT Filed: Jul. 31, 2008
(86) PCT No.: PCT/EP08/06321

§ 371 Date: Aug. 2, 2010

(30) Foreign Application Priority Data
Aug. 3, 2007 (EP) 07015272.3

(51) Int. Cl. H05B 3/14; H01C 17/00

(52) U.S. Cl. 219/553; 29/611

(57) ABSTRACT

The invention relates to an electrically conductive foil made of a thermoplastic matrix and conductive reinforcement fibers, wherein the conductive fibers are disposed in the conductive foil in an approximately isotropic manner, and a method for the production thereof.

The invention relates to an electrically conducting foil which is formed from a thermoplastic matrix and conductive reinforcing fibres, the conductive fibres being disposed virtually isotropically in the conductive foil, and also to a method for production thereof.

Conductive, flat materials which contain conductive fibres or coatings are known in the state of the art.

Thus U.S. Pat. No. 4,534,886 describes electrically conductive nonwovens or papers which contain 5 to 50% by weight of conductive particles. It is characteristic of this conductive material that the conductive fibres are held together by a dispersion binder and hence the nonwoven formation is made possible.

It is disadvantageous with this solution that a nonwoven is involved here which is not particularly robust and is difficult to handle and in which detachment of the fibres, in particular of the conductive fibres, can occur. Therefore conductive fibres can be detached here from the nonwoven composite and can migrate entirely or in fragments; hence contact points between the conductive fibres are partially interrupted, which ultimately can lead via an arc to the formation of sparks and hence to ignition. Furthermore, it is unfavourable that no stable fixed arrangement of the current-conducting components (fibres) is present because of the configuration as a nonwoven. By applying a load in the z direction (surface pressing) contact points between the conductive components are formed again or improved so that a surface pressure-dependent electrical resistance results and hence also no defined, reproducible resistance can be set. The contact tracks are thereby glued only superficially on the conductive nonwoven.

An electrically conductive material in the form of a radiant heater based on nonwovens or paper is known from DE 199 11 519 A1. This electrically conductive material also has the previously described disadvantages since adequate fixing of the conductive components is not achieved here either. The material according to DE 199 11 519 A1 is in fact covered by two laminating foils without the fibres of the material, in particular also the conductive fibres, being fixed locally in addition. The loose character is retained. The contact strips glued superficially on the conductive material are likewise covered with the foil, with the consequence that a sandwich is produced in the region of the contact strips and comprises two insulating foils, the conductive material and the copper contact strip. This multilayer construction on its own involves the danger of local complete detachment of the contact strip; hence the transition resistances are changed with the result of voltage and current peaks which can lead to locally hot places up to the development of sparks and fires.

A further solution for producing an electrically conductive material in layer form is known from WO 01/43507 A1. In the case of this electrically conductive material, fabrics which comprise conductive warp or weft threads at regular spacings are compressed with thermoplastic foils or fabrics in order to form a multilayer sandwich construction comprising two cover layers and a conductive fabric intermediate layer. In the case of this flat conductive material, in addition to the complex production method from a plurality of individual layers, it is particularly disadvantageous that, because of the electrically conductive fabric intermediate layer, low homogeneity is present in the heating pattern since only the electrically conductive warp or weft threads can act as resistance element and become hot. As a result, a strip-shaped heating pattern and no really flat homogeneous heating is produced.

Starting herefrom, it is the object of the present invention to propose a novel electrically conductive material in which no conductive coating is present which, in the application case, tears, lifts off or splits off and then leads to problems, such as spark formation, local voltage peaks and hence temperature peaks and hence represents a safety risk.

In the conductive material, the conductive components are intended to be anchored securely and rigidly so that the contact points of the conductive components are fixed in a defined and invariable manner. Furthermore, the conductive material is intended to have, in the entire surface, a constancy of the electrical conductivity and hence of the surface resistance. Hence, the constancy of the electrical and thermal surface power is intended to be ensured so that a versatile application becomes possible. Furthermore, the material should have no pressure dependency of the electrical resistance and it should be independent of environmental influences, such as air humidity, wetness and other media. The contact strips of the new material should thereby be present securely and invariably without the use of glue and incorporated in the material.

A further object of the present invention is to indicate a corresponding production method for such an electrically conducting material.

The object is achieved with respect to the foil by the features of patent claim 1 and with respect to the production method by the features of patent claim 30.

The sub-claims reveal advantageous developments.

The electrically conducting material according to the invention in the form of a foil is thereby distinguished in that the reinforcing fibres which are contained in the thermoplastic matrix and are formed at least partially from conductive reinforcing fibres are present virtually isotropically in the foil, relative to the x/y direction. The electrically conducting fibres are hence embedded in the thermoplastic matrix, relative to the cross-section of the foil, also homogeneously, virtually isotropically in the x/y direction and not orientated in the z direction. As a result of this fibre orientation, it is achieved that the ratio of electrical conductivity from the x to the y direction changes thereby from 1 to 3, preferably 1.2 to 2.2 and particularly preferred from 1.5 to 2. As a result of the fact that long fibres with a specific defined length, namely of 0.1 to 30 mm, are used and these are distributed and fixed also homogeneously in the thermoplastic matrix, it is ensured that a network-like connection of the electrically conducting fibres relative to each other is present. This conductive network can then also be disrupted locally without total loss of electrical conductivity and hence of the function as electrical radiant heating occurring. As a result of the configuration according to the invention, it is hence for example also possible to adjust specifically the electrical conductivity of the foil by stampings-out and/or perforations. In the case of the conductive foil according to the invention, it must be stressed furthermore that, as a result of the fact that the electrically conductive reinforcing fibres are securely embedded and hence fixed in the thermoplastic matrix, as described above, a very stable composite is produced. As a result of the additional introduction of reinforcing fibres (without electrical conductivity), also the mechanical properties of the foil can hence be controlled corresponding to the application case. Further advantages of the conductive foil according to the invention are the following:
no foil lamination and no laminating adhesive required, hence no adhesive ageing with possibility of changing the electrical transition resistance,
monolayer system, hence no danger of layer separation (delamination),
high inner strength within the foil,
no danger of inner separation of the foil with the danger of open conductive fibre ends lying open and the danger of spark formation and fire development,
no destruction of the conductive fibres as a result of subjection to bending or flexing,
no danger of spark formation as a result of conductive, free fibre fragments,
incorporated, equal-height metallic strip conductors,
ageing-resistant connection of the strip conductor without adhesive,
homogeneous, full-surface heating pattern,
local damage to the heating foil does not disrupt the basic function,
no surface pressure-dependent alteration in the electrical resistance,
humidity-independent, electrical resistance.

In the case of the electrically conductive foil according to the invention, the mechanical properties can be defined by the choice of the thermoplastic and of the fibres and the concentration and mixing ratio thereof and also of the thickness of the foil. Hence parameters, such as elongation, tensile strength and modulus of elasticity, flexural fatigue resistance and the like, can be specifically adjusted such that for example a robust heating foil system which is suitable for the building site can be produced. As a result of the fact that the conductive fibres, in the conductive foils according to the invention, are disposed virtually isotropically and homogeneously within the thermoplastic matrix, an electrical conductivity on the surfaces of the foil cannot be excluded in operation in the so-called safety extra-low voltage range (SELV range), the present foil can be used without additional surface insulation. The electrically conductive foil can however also be used readily for higher voltages if the surfaces of the conductive foil are electrically insulated.

In the case of the conductive foil according to the invention, it is thereby preferred if the electrically conductive reinforcing fibres have a length of 0.1 to 30 mm, preferably of 2 to 18 mm and particularly preferred of 3 to 6 mm. The choice of length of the fibre is important for the reason that it can be ensured by means of conductive long fibres of this type that the electrical conductivity is achieved by the shaping of an electrically conductive homogeneous network in the foil itself. It is hereby favourable in turn if the fibres have at most a thickness of 1 to 15 μm, particularly preferred of 5 to 8 μm. By choice of fibres of this type, it is also still possible to produce a conductivity of the foil itself with relatively low concentrations of conductive electrical reinforcing fibres. According to the present invention, it is provided that, in the thermoplastic matrix, 3 to 45% by weight of reinforcing fibres are contained, the proportion of electrically conductive reinforcing fibres requiring to be favourably at least 0.1% by weight, preferably 0.5 to 20% by weight. The applicant was thereby able to show that it is possible, even with the smallest quantities of electrically conductive reinforcing fibres, e.g. with 0.5% by weight, still to produce conductive foils with a high electrical resistance which, when using normal voltage (230 V), make possible sufficiently low electrical surface powers and hence low temperatures.

As a result of the homogeneous, virtually isotropic distribution of the fibres according to the invention with the prescribed parameters, it is also possible to control the electrical properties of the thermoplastic foil. Thus the electrical conductivity of the foil according to the invention can be controlled with a prescribed density of the foil by the quantity (weight proportion) of the conductive reinforcing fibre to be used. On the other hand, it is also possible that, with a prescribed weight proportion of the conductive reinforcing fibres on the thermoplastic matrix, a corresponding variation in the electrical conductivity is achieved by varying the density of the foil since the number of contact points can consequently be influenced. Finally, it is also possible to influence the electrical conductivity of the foil by means of a reducing change in the conductive surface on the foil with a prescribed proportion of conductive reinforcing fibre or with a prescribed density of the foil due to perforations and/or stampings-out of the foil. This embodiment has the crucial advantage that the foil can be used wherever it is sensible in that for example binders or adhesives can penetrate through the stampings-out or perforations without the conductivity being impaired. This is sensible in particular in the construction sector when using the heating foil between floor tiles and floor screed; good interlayer adhesion is achieved here by tile adhesive penetrating therethrough. When constructing composite materials it is likewise advantageous if adhesive applied on one side penetrates through the perforation and makes a good connection of the layers possible.

The possibility of introducing stampings-out and/or perforations also makes it possible for patterns, e.g. names or trademarks, to be introduced into the foil in a predetermined manner, in the foil itself. As a result, the distinctiveness of the conductive foil can be ensured, which can be made visible even in the constructed state also by thermography.

The foil according to the invention can thereby have a density of 0.25 g/cm³ to 6 g/cm³, preferably of 0.8 to 1.9 g/cm³. The foil can be adjusted as a function of the set method parameters to a thickness in the range between 30 μm to 350 μm.

A further advantage of the foil according to the invention can be seen in the fact that the electrical contact, in a preferred manner, is an integral component of the thermoplastic matrix, i.e. of the electrically conducting foil. In order to produce such an embodiment of the present invention, it is thereby required merely, as described subsequently, to integrate the metallic contact strip jointly in the foil during the production method. The electrical contact is thereby preferably configured as a strip conductor. In a preferred embodiment, such an electrical contact is a metallic contact strip, preferably a copper foil.

The following may be mentioned as advantages:
mechanically robust contacting and protection of the strip conductor without a raised transition point as potential mechanical or optical defect (wall heating, e.g. behind wallpaper),
avoiding the ageing problem of conductive adhesives for the contacting,
prevention of corrosion problems at the transition point from heat conductor to copper contact,
contact strips which are corrosion-protected on the upper side, e.g. aluminium-plated copper contact strips, can be introduced in addition in a flush manner into the foil,
secure adhesive-free connection of the metallic contact strip enables all types of electrical connection technology and also assembling technology of heat foil strips relative to each other:
crimping,
frictional connection with serrated lock washers,
soldering,
welding (ultrasonic, laser, point welding),
riveting,
plug-in connections,
push buttons,
commercially available electrically conductive adhesive tapes.

The configuration of the conductive foil according to the invention makes it possible furthermore that not only lamination of both surfaces of the foil is possible with an insulating layer but also that the electrically conductive foil can be brought into a three-dimensional form by a corresponding shaping tool.

From a material point of view, in particular carbon fibres, metal fibres, conductively doped thermoplastic fibres are suitable for the electrically conductive foil according to the invention for the conductive reinforcing fibres.

In the case of the further reinforcing fibres, all reinforcing fibres known per se from the state of the art can be used. Examples of suitable reinforcing fibres are glass fibres, aramide fibres, ceramic fibres, polyetherimide fibres, polybenzooxazole fibres, natural fibres and/or mixtures thereof. These reinforcing fibres can in principle have the same dimensions as the electrically conductive reinforcing fibres described already above. Suitable fibre lengths are hence 0.1 to 30 mm, preferably 6 to 18 mm and particularly preferred 6 to 12 mm.

All thermoplastic materials can basically be used as thermoplastic matrix. Suitable examples of these are thermoplastics selected from polyether ketones, poly-p-phenylene sulphide, polyetherimide, polyether sulphone, polyethylene, polyethyleneterephthalate, perfluoroalkoxy polymer, polyamide and/or polysulphones.

According to the temperature resistance of the thermoplastics, heating foils which can be used temporarily in the temperature range up to 300° C. and permanently still above 220° C. can be thus produced.

In order to control the properties of the electrically conductive foil, in addition additives can be contained, preferably in a weight quantity up to 10% by weight. Binders can be mentioned here as additives and in fact preferably those binders which are used in the production of the nonwoven mat, as is described in addition subsequently. Further suitable additives are tribologically effective supplements, supplements for strength, impact strength, temperature resistance, heat conductivity, abrasion resistance and/or electrical conductivity.

The additives are used thereby preferably in the form of fibres, fibrils, fibrides, pulps, powders, nanoparticles and nanofibres and/or mixtures hereof.

From a material point of view, suitable examples of the additives with respect to the binders are compounds based on polyacrylate, polyvinyl acetate, polyvinyl alcohol, polyurethane, resins, polyolefins, aromatic polyamides and/or copolymers hereof.

The invention relates furthermore to a method for the production of the above-described conductive foil.

According to the invention, the process thereby is that, in a first step, a nonwoven mat is produced and that then this nonwoven mat is converted after introducing contacts by compression under pressure in a heated tool to form the conductive foil.

An essential element in the method according to the invention is thereby the production of the nonwoven mat. The production of the nonwoven mat is thereby effected basically analogously to EP 1 618 252 B1. A nonwoven mat and a method for production thereof is described therein. It is thereby an essential element of this method that so-called melting fibres and reinforcing fibres are used, from which then the nonwoven mat is formed. The melting fibres are precisely those fibres which form the thermoplastic matrix in the subsequent course of the method. By means of the production process of this nonwoven mat, it is thereby possible to produce the reinforcing fibres, which are formed in the present case at least partially by electrically conductive reinforcing fibres, by means of a suitable laying method on a diagonally extending screen, corresponding distribution of the melting fibres and of the electrically conductive reinforcing fibres. In this procedure, the physical properties of the conductive foil can also be adjusted by corresponding mixing ratios of the conductive fibres and of the reinforcing fibres.

During production of the nonwoven mat, of course also corresponding additives, as already from EP 1 618 252 B1, can also thereby be added in order to achieve a further influence on the electrically conductive foil. An essential element is thereby that corresponding binders are added and in fact here in method step a) in order to achieve fixing of the nonwoven mat as such comprising melting fibres and reinforcing fibres.

The insertion of the electrical contacts (method step b)) can also be effected during method step a), i.e. during the production of the nonwoven mat or during the subsequent compression step (method step c)) so that these contacts are present as an integral component of the electrically conductive foil according to the invention.

With respect to the quantity ratios which are to be used during the method, and also the material choice, reference is made to the above description of the electrically conductive foil.

The invention relates furthermore to the use of the conductive foil as radiant heating, as described above. It has been shown that the foil according to the invention is suitable in particular for low temperature applications in floor, wall, radiant ceiling heating systems, both in the construction field and in automotive applications.

In particular for application in construction, it can also be favourable if a primer is also applied on the foil in order to achieve a minimum adhesion between floor tiles and heating foil and/or floor screed. Such primers are known per se from the state of the art.

The roll shape of the heating foil enables a simple, strip-like design also of large spatial areas. The contacting is thereby effected simply and economically via the parallel connection of the laid-out strips using ring circuits, contact rails or contact bridges or the like.

Furthermore, particular embodiments have proved to be suitable as high temperature radiation heating systems, ancillary heating systems and as an energy source for process heat.

In further applications, the radiant heating system is suitable as:
Mirror heating
Additional heating in air conditioning units
Seat heating
Heating of electronic components.

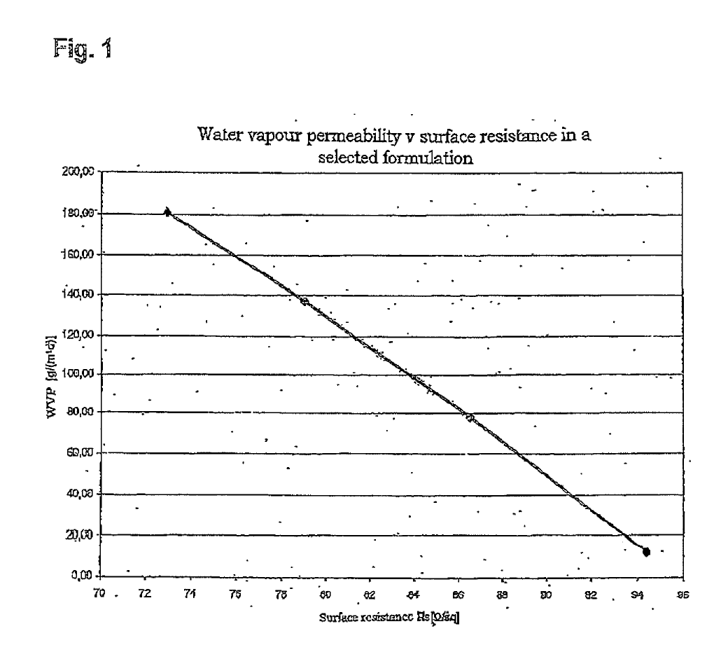

The invention is explained subsequently in more detail with reference to formulation examples and test results with FIGS. 1 to 5.

### 1. Formulation Examples

### 1.1 HICOTEC TP-1

Matrix: 60% by weight PET
Conductive fibres: 3% by weight carbon fibre
Reinforcing fibres: 32% by weight glass fibre+aramide fibre
Binders: 5% by weight

### 1.2 HICOTEC TP-2 and 3

Matrix: 75% by weight PET
Conductive fibres: 3.9% by weight carbon fibre
Reinforcing fibres: 16.1% by weight glass or aramide
Binders: 5% by weight

### 2. Test Results

FIG. 1 shows in a graph, with reference to the material HICOTEC TP-1 (see formulation example 1.1.), the water vapour permeability as a function of the surface resistance.

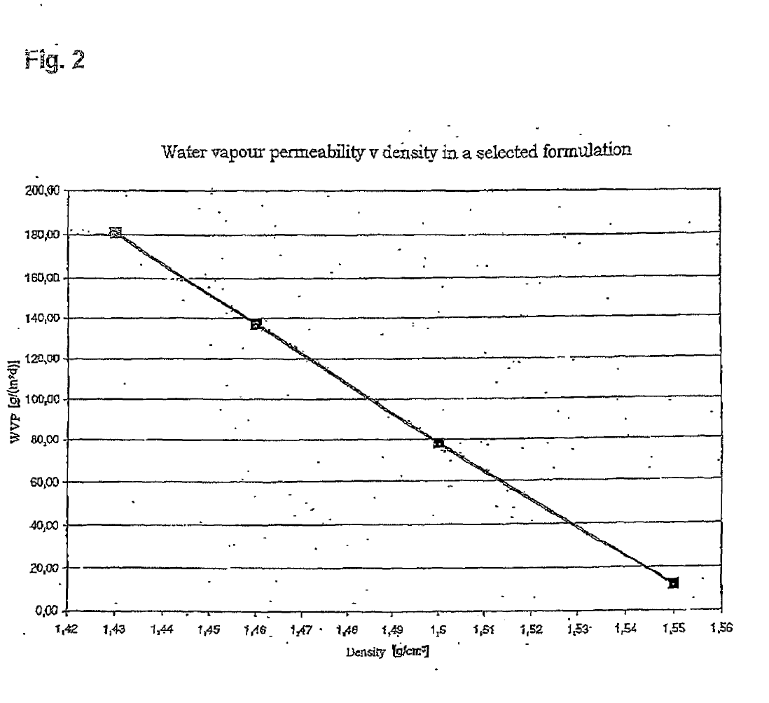

FIG. 2 shows, for the same formulation example (HICOTEC TP-1), the water vapour permeability as a function of the density. The density variation has been produced by varying the compression pressure. The graph is produced by way of example for v=2 m/min.

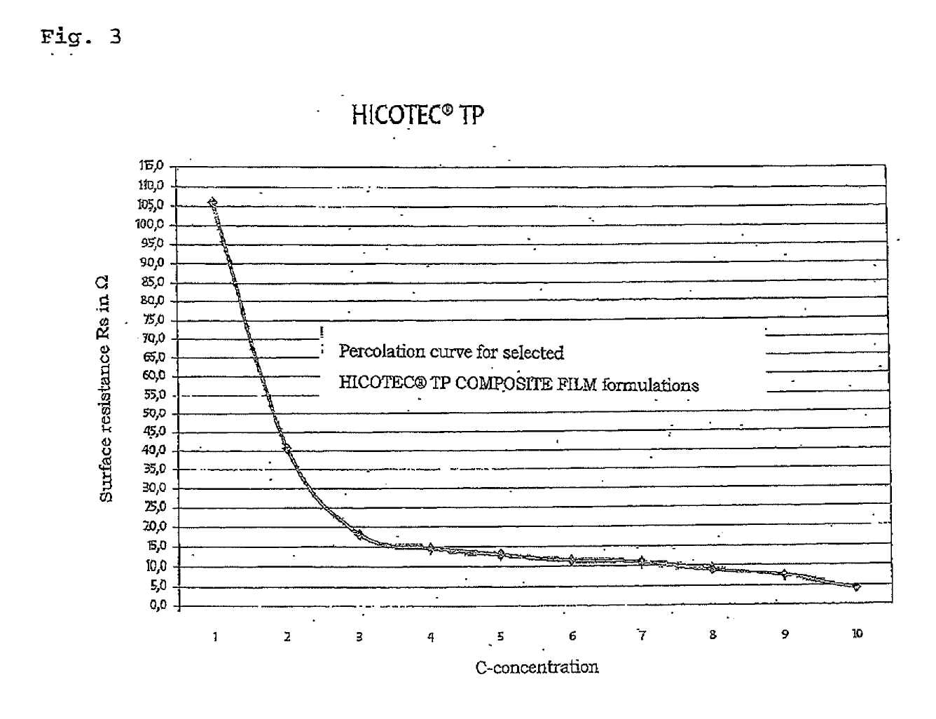

FIG. 3 shows the dependency of the surface resistance upon the concentration of conductive carbon fibres.

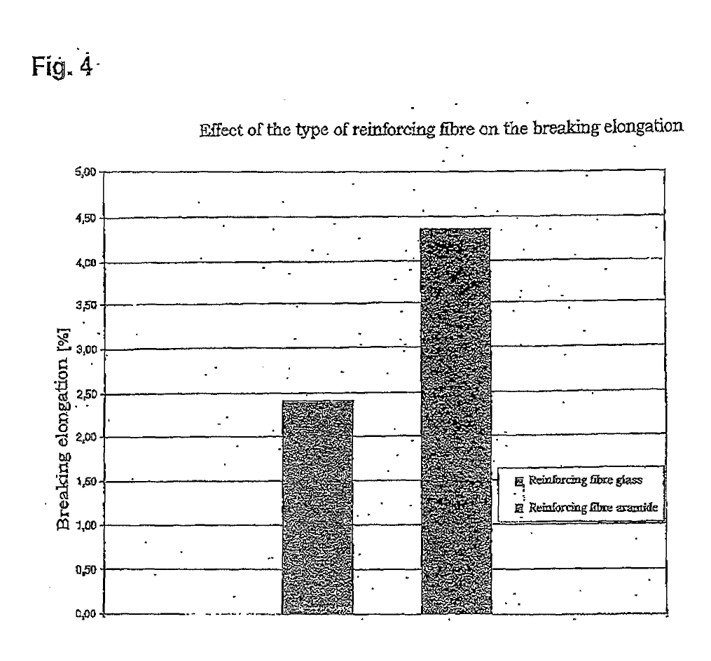

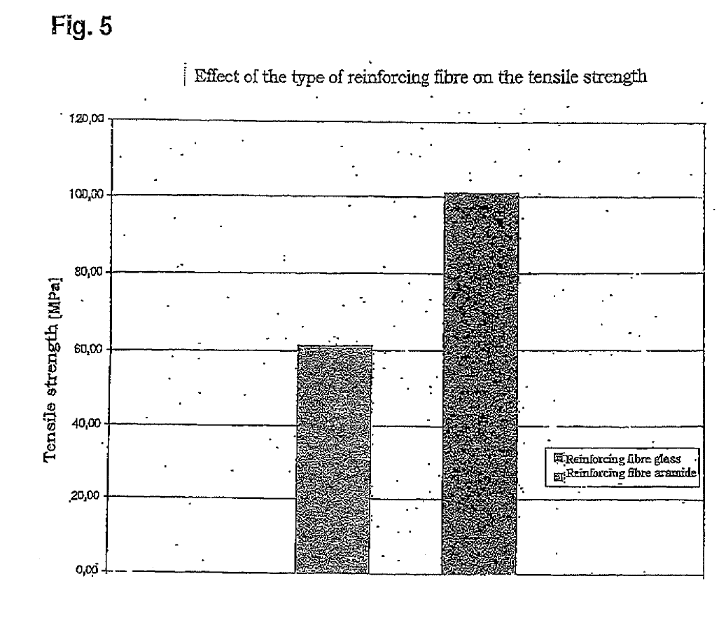

In FIGS. 4 and 5, it is represented by way of example how the choice of reinforcing fibres affects the breaking elongation (FIG. 4) and the tensile strength (FIG. 5). In the graphs, both the values of the breaking elongation for the reinforcing fibre glass (formulation HICOTEC TP-2) and for the formulation HICOTEC TP-3 (aramide) are thereby shown.

1. Conductive foil comprising:
a thermoplastic matrix with 3 to 45% by weight of reinforcing fibers; and
electrical contacts, wherein the reinforcing fibers comprise electrically conductive reinforcing fibers with a fiber length of 0.1 to 30 mm, the electrically conductive reinforcing fibers being present in the foil virtually isotropically in an x-y direction in the thermoplastic matrix.

2. Conductive foil according to claim 1, wherein a ratio of electrical conductivity from the x to the y direction changes from 1 to 3.

3. Conductive foil according to claim 1, wherein the conductive reinforcing fibers have a fiber length in the range of 2 to 18 mm.

4. Conductive foil according to claim 1, wherein the conductive reinforcing fibers have a thickness of 1 to 15 μm.

5. Conductive foil according to claim 1, wherein the conductive reinforcing fibers are selected from the group consisting of carbon fibers, metal fibers, conductively doped thermoplastic fibers and mixtures thereof.

6. Conductive foil according to claim 1, wherein the electrically conductive reinforcing fibers are 0.1% by weight to 20% by weight.

7. Conductive foil according to claim 1, wherein the reinforcing fibers further comprise other fibers selected from the group consisting of glass fibers, aramide fibers, ceramic fibers, polyetherimide fibers, polybenzooxazole fibers, natural fibers and mixtures thereof.

8. Conductive foil according to claim 7, wherein the other fibers have a fiber length of 0.1 to 30 mm.

9. Conductive foil according to claim 1, wherein the thermoplastic matrix comprises thermoplastic selected from the group consisting of polyether ketones, poly-p-phenylene sulphide, polyetherimide, polyether sulphone, polyethylene, polyethyleneterephthalate, perfluoroalkoxy polymer, polyamide, polysulphone and mixtures thereof.

10. Conductive foil according to claim 1, further comprising up to 20% by weight of additives.

11. Conductive foil according to claim 10, wherein the additives are selected from the group consisting of binders, tribologically effective supplements, supplements for strength, impact strength, temperature resistance, heat conductivity, abrasion resistance, electrical conductivity and mixtures thereof.

12. Conductive foil according to claim 10, wherein the additives are in the form of fibers, fibrils, fibrides, pulps, powders, nanoparticles, nanofibers and mixtures thereof.

13. Conductive foil according to claim 11, wherein the binder is selected from the group consisting of polyacrylate, polyvinyl acetate, polyvinyl alcohol, polyurethane, resins, polyolefins, aromatic polyamides and copolymers thereof and mixtures thereof.

14. Conductive foil according to claim 1, wherein an electrical conductivity of the foil at a prescribed weight proportion of the electrically conductive reinforcing fiber is adjusted by varying a density of the foil.

15. Conductive foil according to claim 1, wherein an electrical conductivity of the foil at a prescribed density of the foil is adjusted by a weight proportion of the electrically conductive reinforcing fiber.

16. Conductive foil according to claim 17, wherein the perforations are stampings-out of one or more geometries.

17. Conductive foil according to claim 1, wherein the foil has perforations.

18. Conductive foil according to claim 17, wherein the perforations form a pattern.

19. Conductive foil according to claim 17, wherein an electrical conductivity of the foil at one or both of a prescribed thickness and a prescribed weight proportion of the conductive reinforcing fibers is adjusted by the perforations.

20. Conductive foil according to claim 1, wherein the foil has a density of 0.25 g/cm³ to 6 g/cm³.

21. Conductive foil according to claim 1, wherein the foil has a thickness in the range between 30 to 350 μm.

22. Conductive foil according to claim 1, wherein the electrical contact is an integral component of the conductive foil.

23. Conductive foil according to claim 22, wherein the electrical contact is configured in a strip shape at least in two edge regions of the foil.

24. Conductive foil according to claim 22, wherein the electrical contact is formed by a metallic contact strip.

25. Conductive foil according to claim 24, wherein the metallic contact strip is a copper foil.

26. Conductive foil according to claim 1, wherein the foil is in a plate shape and at least two plate shapes are connected to each other in an electrically conducting manner via contact points.

27. Conductive foil according to claim 26, wherein the connection is selected from crimps, serrated lock washers, solder, rivets, plug-in connections, push buttons and adhesive tapes.

28. Conductive foil according to claim 1, wherein the foil is a three-dimensional formation.

29. Conductive foil according to claim 1, wherein the foil comprises a layer having a first and second surface, the layer comprising an electrically insulating material on at least one of the first and second surface.

30. Conductive foil according to claim 29, wherein both the first and second surfaces have an insulating layer.

31. Method for the production of a conductive foil comprising:
a) forming a thermoplastic matrix from a nonwoven mat comprising a thermoplastic melting fiber and reinforcing fibers;
b) introducing contacts; and
c) compressing the nonwoven mat under pressure in a heated tool in order to form the conductive foil.

32. Method according to claim 31, wherein 55 to 97% by weight of thermoplastic melting fiber and 3 to 45% by weight of reinforcing fibers are used to produce the nonwoven mat, with a fiber length of the thermoplastic melting fiber being less than a fiber length of the reinforcing fiber.

33. Method according to claim 32, further comprising adding 1 to 10% by weight of a binder to the nonwoven mat as additive during production.

34. Method according to claim 32, wherein the fiber length of the thermoplastic melting fiber is in a range of 2 to 6 mm.

35. Method according to claim 31, wherein the thermoplastic melting fiber is selected from polyetherether ketone, poly-p-phenylene sulphide, polyetherimide, polyether sulphone, polyethylene, polyethyleneterephthalate, perfluoroalkoxy polymer, polyamide, polysulphone and mixtures thereof.

36. Method according to claim 33, wherein the binder is selected from polyacrylate, polyvinyl acetate, polyvinyl alcohol, polyurethane, resins, polyolefins, aromatic polyamide, copolymers thereof and mixtures thereof.

37. Method according to claim 36, wherein the binder is one or more of fibrils, fibrides and fibrous binders.

38. Method according to claim 33, further comprising adding further additives during production of the nonwoven mat.

39. Method according to claim 31, wherein the nonwoven mat has a surface mass of 8 to 400 g/m².

40. Method according to claim 31, wherein the nonwoven mat has a density of 30 to 500 kg/m³.

41. Method according to claim 31, wherein the nonwoven mat has a thickness of 0.1 mm to 4 mm.

42. Method according to claim 31, wherein the contact is copper strips.

43. Method according to claim 31, wherein compressing the nonwoven mat occurs at a pressure of 0.05 to 15 N/mm².

44. Method according to claim 31, further comprising perforating the conductive foil after the step of compressing.

45. Use of the conductive foil according to claim 1 as floor heating under one or both of floor tiles and wooden floors.

46. (canceled)
